(19) United States
(12) Patent Application Publication
(10) Pub. No.: US 2007/0261782 A1
(43) Pub. Date: Nov. 15, 2007

(54) Method for sublimating a decoration on the surface of an object

(76) Inventors: Robert D. Frye, Gainesville, GA (US); Keith A. Moreau, Hillsboro, NH (US)

Correspondence Address: TAYLOR & AUST, P.C., P.O. Box 560, 142. S Main Street, Avilla, IN, 46710, US

(21) Appl. No.: 11/430,319

(22) Filed: May 9, 2006

(51) Int. Cl. B44C 1/165

(52) U.S. Cl. 156/230; 156/285; 156/382

(57) ABSTRACT

A kit for sublimating a decoration into a surface of an object includes a plurality of particles for blasting into the surface of the object. At least one inker is for wrapping about the object. At least one membrane is for encapsulating the object and the inker. A vacuum hose is for mating to the membrane with an airtight connection. An oven is for heating the object.

### FIELD OF THE INVENTION

The present invention is generally related to improvements regarding a method for sublimating a decoration on the surface of an object, and more particularly is related to a method for sublimating a decoration on the surface of an object in a durable manner.

### BACKGROUND OF THE INVENTION

In the sublimation art are known machines of such type, generally consisting of two interconnectable frames, in which one of the frames is integral with at least one membrane capable of elastic deformation. An inker, an object to be decorated, and a second inker are inserted into the membrane. The inkers have decorated surfaces on at least one side and the decorated surfaces are positioned adjacent a surface of the object. The machine is placed under vacuum so that the inkers, and in particular their decorated surfaces, are pressed against the surface of the object. The assembly, maintained under pressure, is placed in a furnace for sublimating the decoration over a few millimeters of depth into the surface of the object.

This type of machines presents, however, some disadvantages with respect to durability of the sublimated image. It has been shown that images sublimated into objects using the type of sublimating process described above will fade, run, and otherwise become diminished in appearance when exposed to regular and/or substantial steam. For objects that are otherwise designed for regular and/or substantial steam exposure, a more rugged sublimated image would be desirable.

Thus, a heretofore unaddressed need exists in the industry to address the aforementioned deficiencies and inadequacies.

### SUMMARY OF THE INVENTION

Embodiments of the present invention provide a kit and method for sublimating a decoration into a surface of an object. Briefly described, in architecture, one embodiment of the system, among others, can be implemented as follows. The kit for sublimating a decoration into a surface of an object includes a plurality of particles for blasting into the surface of the object. At least one inker is for wrapping about the object. At least one membrane is for encapsulating the object and the inker. A vacuum hose is for mating to the membrane with an airtight connection. An oven is for heating the object.

The present invention can also be viewed as providing methods for sublimating a decoration into a surface of an object. In this regard, one embodiment of such a method, among others, can be broadly summarized by the following steps: selecting a metal object for sublimation; B-blasting the object; priming the object; wrapping the object within at least one inker having at least one decorative design; vacuum-sealing the object and the at least one inker within a membrane; and heating the membrane and contents thereof for a period of time, wherein the decorative design is absorbed into a surface of the object.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cross-sectional view of a decorating device, in accordance with a first exemplary embodiment of the present invention.

FIG. 2 is an exploded cross-sectional view of a decorating device, in accordance with a second exemplary embodiment of the present invention.

FIG. 3 is a cross-sectional view of the decorating device, in accordance with the second exemplary embodiment of the present invention.

FIG. 4 is a top view of the decorating device, in accordance with the second exemplary embodiment of the present invention.

FIG. 5 is a cross-sectional view of the decorating device, in accordance with the second exemplary embodiment of the present invention.

FIG. 6 is a top view of the decorating device, in accordance with the second exemplary embodiment of the present invention.

FIG. 7 is a cross-sectional view of a decorating device, in accordance with a third exemplary embodiment of the present invention.

FIG. 8 is a cross-sectional view of the decorating device, in accordance with the third exemplary embodiment of the present invention.

FIG. 9 is a flowchart illustrating a method of sublimating using the decorating device, in accordance with the first exemplary embodiment of the invention.

### DETAILED DESCRIPTION

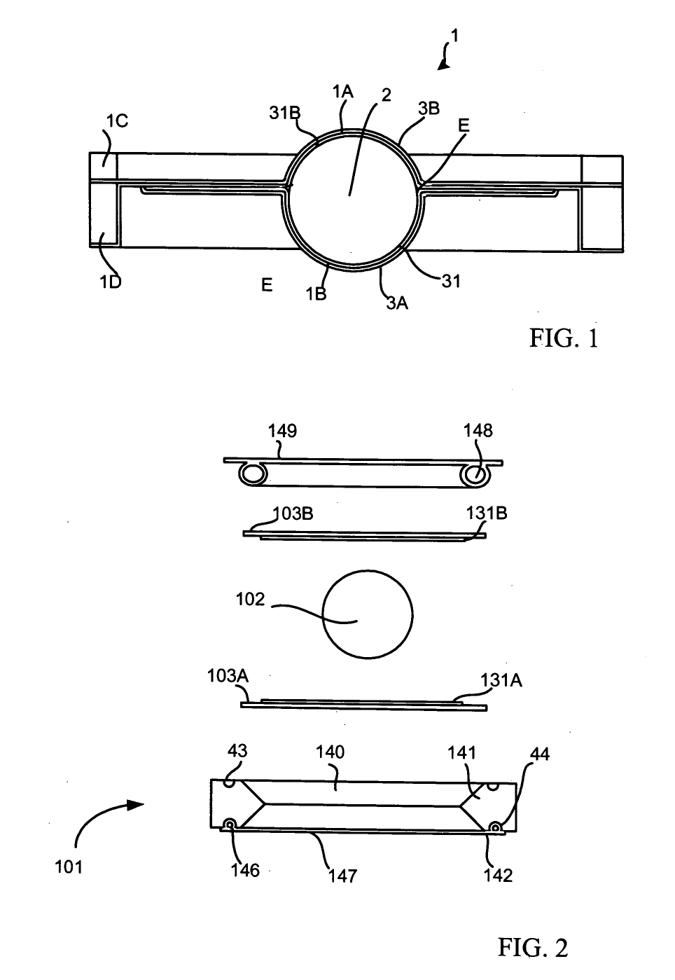

FIG. 1 is a cross-sectional view of a decorating device 1, in accordance with a first exemplary embodiment of the present invention. The decorating device 1 includes an upper membrane 1A and a lower membrane 1B, each attached to a rigid frame 1C, 1D, swiveling with respect to each other. Prior to closing the frames 1C, 1D, an inker 3A, an object 2 to be decorated, and another inker 3B were inserted between the membranes 1A, 1B. Each inker 3A, 3B is provided with a surface that is covered with a decoration 31A, 31B that will come into contact with the surface of the object 2 to be decorated. The decorating device 1 is then placed under vacuum, deforming the membranes 1A, 1B and the inkers 3A, 3B so that the decorations 31A, 31B are pressed against the object 2. The decorating device 1 is inserted into a heated environment to enable the transfer of the decorations 31A, 31B of each inker 3A, 3B to the surface of the object 2.

FIG. 2 is an exploded cross-sectional view of a decorating device 101, in accordance with a second exemplary embodiment of the present invention. The decorating device 101 includes an elastically deformable frame 140, made out of a plastic material (e.g., silicone) that is resistant to high temperatures. The elastically deformable frame 140 includes an upper surface 141 and a bottom surface 142 that are provided with a round or analogous groove around the entire frame. The elastically deformable frame 140 is perpendicularly pierced between a first groove 143 and a second groove 144 of a hole (not shown) that permits the tight fitting of a metal connecting piece 145 (shown in FIG. 4), the function of which will be discussed further herein.

The first groove 143, provided on the upper surface 141 of the elastically deformable frame 140, may house under pressure a first retaining ring 148 of the same shape, that is provided in order to tightly retain a peripherical border of a first elastic membrane 149. The second groove 144, provided on the bottom surface 142 of the elastically deformable frame 140, may house under pressure a second retaining ring 146 of the same shape, that is provided in order to tightly retain a peripherical border of a second elastic membrane 147, substantially identical to the first elastic membrane 149. The first elastic membrane 149 and the second elastic membrane 147 are made of a material, such as silicone, comparable to the one used for the elastically deformable frame 140. The retaining rings 146, 148 may be long enough to encircle the entire periphery of the elastically deformable frame 140.

Prior to installing the first elastic membrane 149, the operator positions on the second elastic membrane 147 a first inker 103A in such a manner that the first decoration 131A of the first inker 103A does not come into contact with the second elastic membrane 147. Thereafter, the object 102 to be decorated is placed on the first decoration 131A of the first inker 103A while a second inker 103B is placed in such a manner that the second decoration 131B of the second inker 103B is in contact with said object 102. The inkers 103A, 103B may be identical and may be made of an elastic material, such as a fabric, a knitted fabric or a thin sheet of a non-woven material.

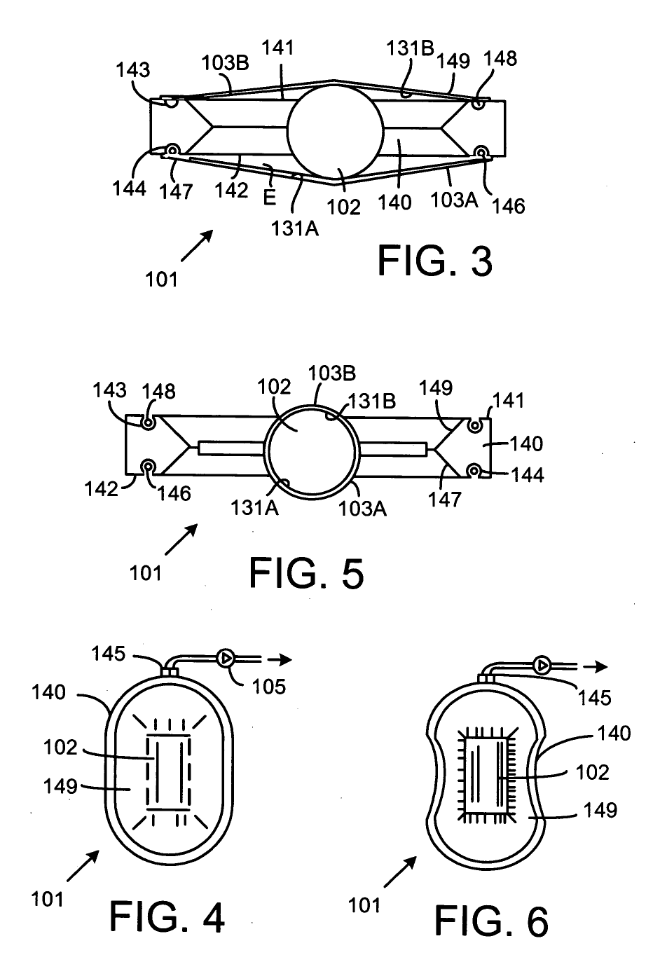

The operator positions the first elastic membrane 149 in such a manner that it attaches to the first retaining ring 148 on the upper surface of the elastically deformable frame 140. FIG. 3 is a cross-sectional view of the decorating device 101, in accordance with the second exemplary embodiment of the present invention. FIG. 4 is a top view of the decorating device 101, in accordance with the second exemplary embodiment of the present invention. As shown in FIG. 3, the decorating device 101 includes a completely sealed interior space E. As shown in both FIG. 3 and FIG. 4, the decorating device 101 is completely sealed, but air remains trapped within the elastic membranes 147, 149.

As shown in FIG. 4, the decorating device 101 is connected to a vacuum pump 105 by means of the metal connecting piece 145 to generate a depression in the space E, limited by the elastically deformable frame 140 and the elastic membranes 147, 149. FIG. 5 is a cross-sectional view of the decorating device 101, in accordance with the second exemplary embodiment of the present invention. FIG. 6 is a top view of the decorating device 101, in accordance with the second exemplary embodiment of the present invention. It can be observed that with a sufficient vacuum, the elastically deformable frame 140 becomes distorted in its middle so that the elastic membranes 147, 149 and the inkers 103A, 103B correspond in shape to the shape of the object 102, even at the level of the contact point. The decorating device 101 is placed inside of a furnace that may be preheated, for instance, to a temperature of approximately 180 to 200 degrees Fahrenheit so that the decorations 131A, 131B of the inkers 103A, 103B are transferred to the surface of the object 102 to be decorated.

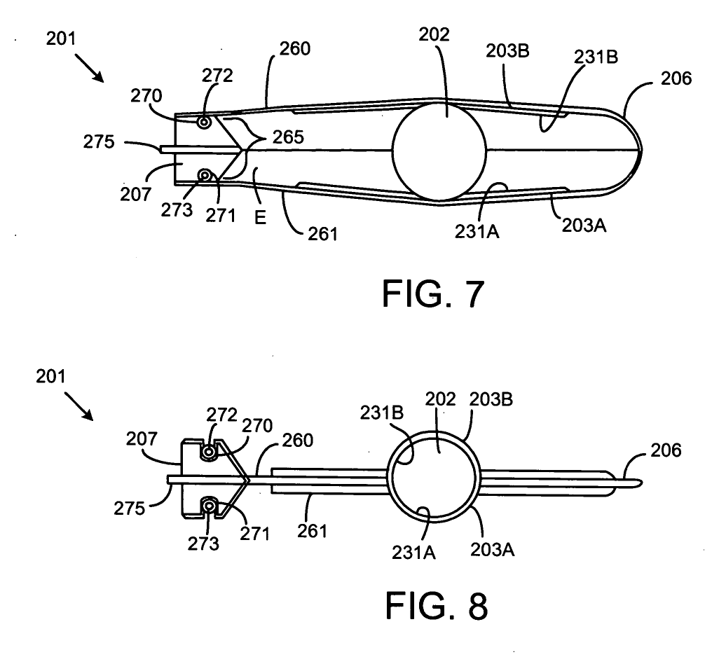

FIG. 7 is a cross-sectional view of a decorating device 201, in accordance with a third exemplary embodiment of the present invention. The third exemplary embodiment is similar to the second exemplary embodiment, with a primary exception being that a single elastic membrane bag 206 replaces the elastic membranes. The single elastic membrane bag 206 is folded in such a manner that it forms two substantially symmetrical sections 260, 261 having a similar surface area. A single aperture 265 is formed in the single elastic membrane bag 206 for the placing of the inkers 203A, 203B and the object 202 to be decorated inside of the single elastic membrane bag 206. The inkers 203A, 203B are positioned in such a manner that their decorations 231A, 231B are in contact with the outer surface of the object 202.

The single aperture 265 of the single elastic membrane bag 206 interacts with a rod 207 so as to tightly close the single elastic membrane bag 206. The rod 207 is provided with two grooves, an upper groove 270 and a lower groove 271, that are provided for the insertion of retaining rings 272, 273. The retaining rings 272, 273 hold the free extremities of the substantially symmetrical sections 260, 261 in the grooves 270, 271, respectively, in order to close the single elastic membrane bag 206 and constitute the sealed space E. The rod 207 is perpendicularly pierced and between the grooves 270, 271 of a hole that permits the tight fitting of a metal connecting piece 275.

FIG. 8 is a cross-sectional view of the decorating device 201, in accordance with the third exemplary embodiment of the present invention. The connecting piece 275 is connected to a vacuum pump that allows the obtaining of a depression inside the single elastic membrane bag 206, in such a manner that the substantially symmetrical sections 260, 261, the inkers 203A, 203B and the decorations 231A, 231B correspond in shape to the shape of the object 202, and in particular at the level of the contact point. The decorating device 201 is placed inside a possibly preheated furnace in order to effectuate the transfer of the decorations onto the surface of the object 202.

FIG. 7 and FIG. 8 show one possible embodiment for the present invention using a single elastic membrane bag 206. Those having ordinary skill in the art will recognize that other variations on the single elastic membrane bag 206 may be devised, which the primary requirements being that the object 202 and the inkers 203A, 203B must be contained within the single elastic membrane bag 206 and the single elastic membrane bag 206 must be capable of being vacuum-sealed over the object 202 and the inkers 203A, 203B.

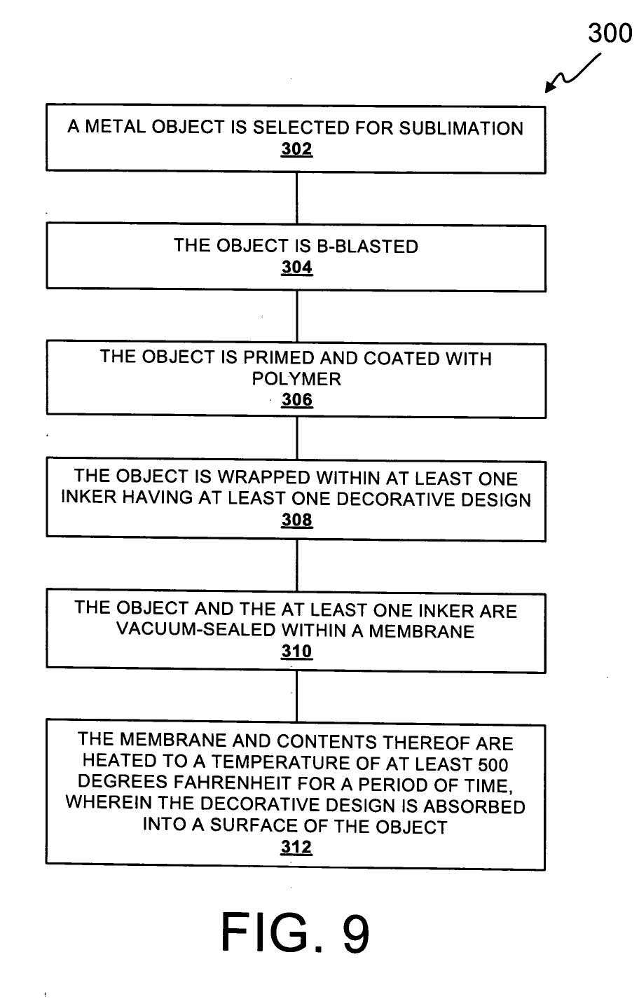

FIG. 9 is a flowchart 300 illustrating a method of sublimating, using the decorating device 1, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 302, a metal object 2 is selected for sublimation. The object 2 is B-blasted (block 304). The object 2 is primed with paint and coated with a polymer (block 306). The object 2 is wrapped within at least one inker 3A, 3B having at least one decorative design 31A, 31B (block 308). The object 2 and the at least one inker 3A, 3B are vacuum-sealed within a membrane 1A, 1B (block 310). The membrane 1A, 1B and contents thereof are heated for a period of time, wherein the decorative design 31A, 31B is absorbed into a surface of the object 2 (block 312).

B-blasting is a technique for providing texture to an item. A special chamber may be used to perform B-blasting. The object 2 may be cleaned and placed within the special chamber. Particles are projected at the object 2 at a high velocity, joining with the object 2. In some practices of this invention, the object 2 may be blasted for about 20 minutes with about 75 pounds of particles. In the present invention, the B-blasting is performed to provide a more suitable surface to the object 2, allowing the object 2 to be more durable after sublimation. The particles used may be sand or other dry media. Those having ordinary skill in the art may know other similarly effective particles.

The object 2 may be cleaned before and/or after B-blasting. Cleaning may involve agitating the object 2 in tank of heated, soapy water and thoroughly rinsing the object. After the object 2 has been B-blasted, cleaning may result in removing some loose particles from the object 2. Cleaning is also useful for preparing the object 2 to be primed. Other means of cleaning, including hand washing, the object 2 may be known to those having ordinary skills in the art and are considered within the scope of the invention.

The priming provides another layer on the object 2 that will absorb sublimated ink. The paint should substantially cover the object 2 evenly. The object 2 may be primed using a paint spray gun, a paintbrush, or other tools known to those having ordinary skill in the art. The primer may be absorbed, in part, by the particles blasted into the object 2. The object 2 is also coated with a polymer. The polymer may, for example, be polyester. The polymer may be applied in any of a number of ways known to those having ordinary skill in the art for applying polymers to metals, including electrostatically spraying the polymer onto the object 2.

After priming and after coating, the object 2 may be baked. Baking the object 2 operates to cure the priming. Baking the object 2 may involve putting the object 2 in an oven. The object may bake at temperatures exceeding four hundred degrees Fahrenheit. The object 2 may also be heated immediately prior to being primed. Other means of baking to cure the object 2 may be known to those having ordinary skills in the art and are considered within the scope of the invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for sublimating a decoration into a surface of an object, the system comprising:
means for texturizing an object;
means for vacuum-sealing at least one inker with the object; and
means for heating the vacuum-sealed inker and object.

2. The system of claim 1, further comprising means for priming the object.

3. The system of claim 1, further comprising means for wrapping the object with at least one inker.

4. The system of claim 1, further comprising means for cleaning the object.

5. A method of sublimating a decoration into a surface of a metal object, the method comprising the steps of:
selecting the metal object for sublimation;
B-blasting the object;
priming the object;
coating the object with a polymer;
wrapping the object within at least one inker having at least one decorative design;
vacuum-sealing the object and the at least one inker within a membrane; and
heating the membrane and contents thereof for a period of time, wherein the decorative design is absorbed into the surface of the object.

6. The method of claim 5, wherein the step of B-blasting further comprises blasting the object with particles of sand.

7. The method of claim 5, further comprising the step of joining a plurality of membrane sheets to form the membrane.

8. The method of claim 5, wherein the step of B-blasting the object precedes the step of priming the object.

9. The method of claim 5, wherein the step of coating precedes the step of wrapping of the inkers.

10. The method of claim 5, wherein the step of wrapping further comprises placing a plurality of inkers adjacent to and substantially covering the surface of the object.

11. The method of claim 5, wherein the step of heating the membrane further comprises heating the membrane and contents thereof to a temperature of at least 180 degrees Fahrenheit for a period of time.

12. The method of claim 5, further comprising the step of cleaning the object after B-blasting the object.

13. The method of claim 5, further comprising the step of baking the object after priming the object.

14. A kit for sublimating a decoration into a surface of an object, the kit comprising:
a plurality of particles for blasting into the surface of the object;
at least one inker for wrapping about the object;
at least one membrane for encapsulating the object and inker;
a vacuum hose for mating to the membrane with an air-tight connection; and
an oven for heating the object.

15. The kit of claim 14, wherein the plurality of particles further comprises particles of sand.

16. The kit of claim 14, wherein the at least one inker further comprises a plurality of inkers for placing adjacent to and substantially covering the surface of the object.

17. The kit of claim 14, wherein the at least one membrane further comprises a plurality of membrane sheets joined together.

18. The kit of claim 14, further comprising paint for priming the object.

19. The kit of claim 14, further comprising a blasting chamber for blasting the object with the plurality of particles.

20. The kit of claim 14, further comprising a hand-operated sand blaster for blasting the object with the plurality of particles.
